(19) United States
(12) Patent Application Publication
(10) Pub. No.: US 2026/0194617 A1
(43) Pub. Date: Jul. 9, 2026

(54) POSITION DETERMINATION SYSTEM, POSITION DETERMINATION METHOD AND NON-TRANSITORY COMPUTER READABLE STORAGE MEDIUM

(71) Applicant: DENSO CORPORATION, Kariya-city (JP)

(72) Inventors: Youhei SEKIYA, Nisshin-city (JP); Takashi Saiki, Kariya-shi (JP)

(21) Appl. No.: 19/551,429

(22) Filed: Feb. 26, 2026

Related U.S. Application Data
(63) Continuation of application No. PCT/JP2024/031592, filed on Sep. 3, 2024.

(30) Foreign Application Priority Data
Sep. 6, 2023 (JP) 2023-144710

(51) Int. Cl. G01S 5/02; G01S 5/14; G01S 13/76; H01Q 1/32

(52) U.S. Cl. CPC G01S 5/0284; G01S 5/14; G01S 13/765; H01Q 1/3241

(57) ABSTRACT

A position determination system includes: a communication device that executes wireless communication with a mobile device of a user of a vehicle; and a control unit that determines a position of the mobile device based on a reception strength of a signal from the mobile device. The control unit includes: a threshold storage unit that registers a threshold value designed based on a communication characteristic of a reference device; and a characteristic data storage unit that stores data indicating the communication characteristic of the mobile device. The control unit executes: acquiring the reception strength; generating characteristic data indicating a difference in the communication characteristic between the mobile device and the reference device; storing the characteristic data in the characteristic data storage unit; and determining the position of the mobile device based on the characteristic data, the reception strength, and the threshold value.

### CROSS REFERENCE TO RELATED APPLICATION

The present application is a continuation application of International Patent Application No. PCT/JP 2024/031592 filed on Sep. 3, 2024, which designated the U.S. and claims the benefit of priority from Japanese Patent Application No. 2023-144710 filed on Sep. 6, 2023. The entire disclosures of all of the above applications are incorporated herein by reference.

### TECHNICAL FIELD

The present disclosure relates to a technique for determining a position of a mobile device with respect to a vehicle.

### BACKGROUND

A conceivable technique teaches a configuration for determining whether a mobile device is disposed inside a vehicle based on whether the reception power (in other words, the reception strength) of a signal transmitted from the mobile device at an in-vehicle antenna is equal to or greater than a predetermined value.

### SUMMARY

According to an example, a position determination system may include: a communication device that is configured to be able to execute wireless communication with a mobile device used by a user of a vehicle using a predetermined communication method; and a controller that determines a position of the mobile device relative to the vehicle based on a reception strength of a signal from the mobile device received by the communication device. The controller may include: at least one of (i) a circuit and (ii) a processor with a memory storing computer program code executable by the processor; a threshold storage that registers a threshold value for the reception strength to determine the position of the mobile device, the threshold value being designed based on a communication characteristic of a predetermined reference device; and a characteristic data storage that stores data indicating the communication characteristic of the mobile device. The at least one of the circuit and the processor is configured to cause the controller to execute: acquiring the reception strength of the signal from the communication device; generating characteristic data indicating a difference in the communication characteristic between the mobile device and the reference device based on the reception strength of the signal detected when the mobile device is disposed in a predetermined position; storing generated characteristic data in the characteristic data storage; and determining the position of the mobile device based on the characteristic data stored in the characteristic data storage, the reception strength of the signal detected by the communication device, and the threshold value.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing an overall view of a vehicle electronic key system;

FIG. 2 is a diagram showing an example of an anchor mounting position;

FIG. 3 is a flowchart for explaining an outline of the operation of the smart ECU;

FIG. 4 is a flowchart for explaining an outline of a position determination process;

FIG. 5 is a function block diagram of a smart ECU;

FIG. 6 is a flowchart of a position determination related process; and

FIG. 7 is a flowchart of a characteristic learning process.

### DETAILED DESCRIPTION

In recent years, an in-vehicle system has been developed that a general-purpose mobile device such as smartphones is usable as a vehicle key. The in-vehicle system communicates with the mobile device via short-range wireless communication (hereinafter, SRWC). Here, SWRC includes Bluetooth (registered trademark) Low Energy, Wi-Fi (registered trademark), and the like. The in-vehicle system may determine the position of the mobile device based on the reception strength of the SWRC signal transmitted from the mobile device.

However, the transmission power and antenna configuration (i.e., directivity) of smartphone may differ depending on the model or type of the smartphone. The mobile device used by the user (hereinafter referred to as the user device) may be different from a reference device. The reference device in this context is a mobile device that the manufacturer uses to set the reception strength threshold. In a configuration in which the position of a user device is determined by comparing the reception strength of the signal from the user device with a threshold designed using a reference device, the position may be determined incorrectly due to the communication characteristics of each mobile device.

The present embodiments have been made in light of the above circumstances, and one of its objects is to provide a technique that can reduce the risk of erroneously determining the position of a mobile device.

A position determination system described herein is an in-vehicle system.

The in-vehicle system includes: a communication device that is configured to be able to execute wireless communication with a mobile device used by a user of a vehicle using a predetermined communication method; and a control unit that determines a position of the mobile device relative to the vehicle based on a reception strength of a signal from the mobile device received by the communication device. The control unit includes: a threshold storage unit that registers a threshold value for the reception strength to determine the position of the mobile device, the threshold value being designed based on a communication characteristic of a predetermined reference device; and a characteristic data storage unit that stores data indicating the communication characteristic of the mobile device. The control unit acquires the reception strength from the communication device. The control unit generates characteristic data indicating a difference in the communication characteristic between the mobile device and the reference device based on the reception strength of the signal detected when the mobile device is disposed in a predetermined position, and stores generated characteristic data in the characteristic data storage unit. The control unit is configured to determine a position of the mobile device based on the characteristic data stored in the characteristic data storage unit, the reception strength of the signal detected by the communication device, and a threshold value.

According to the above configuration, the position of the mobile device is determined using the characteristic data that indicates the difference in the communication characteristic between the mobile device used by the user and the reference device. Therefore, it is possible to reduce the risk of erroneous determination of the position due to the difference in the communication characteristic between mobile devices.

The position determination method described in the present embodiments includes: acquiring a reception strength of a signal from a mobile device through a communication device which is configured to be able to execute wireless communication with the mobile device in a predetermined communication method; accessing a threshold storage unit which registers a threshold value for the reception strength to determine a position of the mobile device, the threshold value being designed based on communication characteristic of a predetermined reference device; reading out the threshold value from the threshold storage unit; generating characteristic data indicating the communication characteristic of the mobile device based on the reception strength of the signal detected when the mobile device is disposed in a predetermined position; storing generated characteristic data in a characteristic data storage unit; and determining the position of the mobile device based on the characteristic data stored in the characteristic data storage unit, the reception strength of the signal detected by the communication device, and the threshold value.

The reference symbols in parentheses described in the features indicate correspondence with the example described in the embodiments described as one aspect of the present embodiments, and do not limit the technical scope of the present embodiments.

The following will describe an embodiment of the present disclosure with reference to the drawings. The present disclosure is not limited to the following embodiments. The configurations disclosed below may be implemented in various modifications within the scope of the gist thereof. The various modified examples may be combined as appropriate within the scope of the present embodiments without causing any technical contradiction. The present embodiments also include a configuration that is not explicitly stated and is formed by combining multiple modified examples. In the following description, components having the same functions are denoted by the same reference numerals, and specific descriptions thereof may be omitted. When only a part of a configuration is mentioned, the description given elsewhere may apply to the other parts.

### Overall Configuration

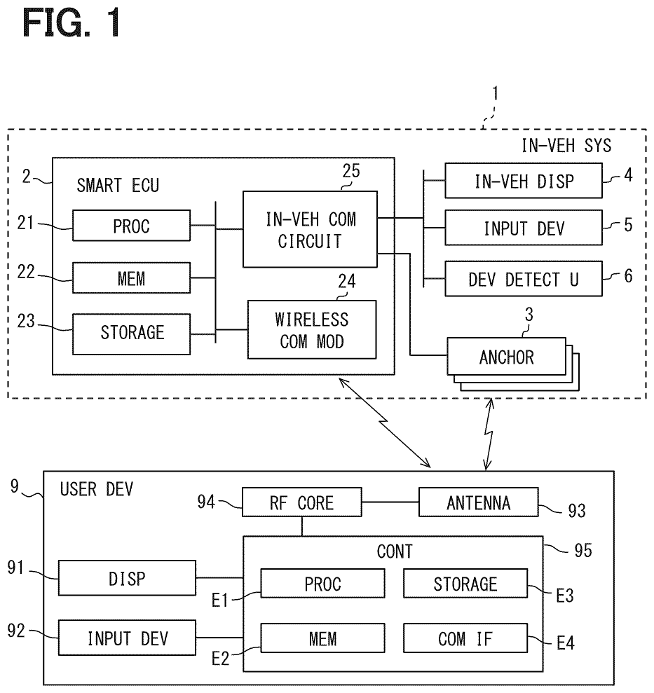

As shown in FIG. 1, the vehicle electronic key system according to the embodiment includes an in-vehicle system 1 and a user device 9. The in-vehicle system 1 is a system mounted on a vehicle Hv. The in-vehicle system 1 includes a smart ECU 2. The ECU is an abbreviation of Electronic Control Unit. In the following description, the in-vehicle system 1 and the vehicle Hv may be interpreted as interchangeable. The in-vehicle system 1 is a system that determines the position of the user device 9 and controls the locking state of the doors of the vehicle Hv based on the determination result. The in-vehicle system 1 corresponds to a position determination system.

The user device 9 is a wireless communication terminal carried by a user (in other words, a portable device). The user device 9 is linked to the smart ECU 2. That is, the smart ECU 2 has device information of the user device 9 registered therein. The device information includes a device identification number (hereinafter referred to as a device ID). The device ID may be a device address or a universally unique identifier (i.e., UUID), for example. The smart ECU 2 may have device information of multiple user devices 9 registered therein.

Both the smart ECU 2 and the user device 9 include a short-range communication module. The short-range communication module is a communication module that enables short-range communication. Here, the short-range communication means communication conforming to a predetermined wireless communication standard in which the practical communication distance is 5 meters to 50 meters, and at most about 100 meters. The short-range communication may be Bluetooth (registered trademark) Low Energy (hereinafter referred to as Bluetooth LE), Wi-Fi (registered trademark), or the like. In the following description and drawings, the short-range communication may be referred to as SRWC (i.e., Short Range Wireless Communication). In addition, in the embodiments, a signal transmitted and received in the short-range communication may be referred to as a short-range communication signal or an SRWC signal. In particular, the SRWC signal transmitted from the user device 9 is also referred to as a device signal.

Below, the operation of each part will be explained using an example in which the short-range communication (i.e., SRWC) is the Bluetooth LE. Further below, the user device 9 is set to operate as a peripheral in the Bluetooth LE, and the smart ECU 2 is set to operate as a central. The roles of the user device 9 and the smart ECU 2 may be interchanged. The SRWC may be a communication that can use multiple frequencies (in other words, channels). The SRWC may be a communication method in which channel hopping technique is introduced.

### In-Vehicle System

In addition to the smart ECU 2, the in-vehicle system 1 includes other devices such as a plurality of anchors 3, an in-vehicle display 4, an input device 5, and a device detection unit 6. The smart ECU 2 is connected to each of the plurality of anchors 3 via a dedicated communication cable. The smart ECU 2 is connected to an in-vehicle display 4, an input device 5, and a device detection unit 6 via an in-vehicle network. The in-vehicle network is a communication network established within the vehicle Hv. The in-vehicle network standard may be any standard such as Controller Area Network (i.e., CAN, registered trademark), Ethernet (registered trademark), or FlexRay (registered trademark). The connection between the devices may be changed as appropriate.

The smart ECU 2 is an ECU that determines the position of the device in cooperation with the anchor 3. As will be described later, the anchor 3 is a wireless communication module for executing ranging communication with the user device 9. The ranging communication in the embodiments refers to the wireless communication for measuring the distance between communication devices based on the time of flight of a signal or phase information of a reception signal.

The smart ECU 2 may have a function of executing vehicle control according to the determined position of the device. In the embodiments, the position of the device refers to the relative position of the user device 9 with respect to the vehicle Hv. The determination of the position of the device is equivalent to the determination of the position of the user. The term “the position of the device” may be read as “the position of the user”. The smart ECU 2 controls the operation of the anchor 3. Here, the vehicle control may be the switching of the locking state of the doors (for example, unlocking) or the switching of the on and off state of the vehicle power supply.

The smart ECU 2 includes a processor 21, a memory 22, a storage 23, a wireless communication module 24, and an in-vehicle communication unit 25. The processor 21 may be a CPU (i.e., Central Processing Unit) or an MPU (i.e., Micro Processing Unit). The processor 21 corresponds to the control unit. The memory 22 may be a volatile storage medium such as a RAM (i.e., Random Access Memory). The memory 22 may be a component for temporarily storing data received from other in-vehicle devices, calculation results of the processor 21, programs, and the like. The storage 23 is a rewritable non-volatile memory. The storage 23 is realized by at least one type of non-transitory tangible storage medium such as a semiconductor memory, a magnetic medium, or an optical medium. The storage 23 may include multiple types of storage media, such as a ROM (i.e., Read Only Memory) and a flash memory.

The storage 23 may store the device ID and anchor data of the user device 9, and authentication data. The anchor data is data that indicates the mounting positions of a plurality of anchors 3 in the vehicle Hv. The authentication data may be data for authenticating the user device 9 (for example, a key code).

The storage 23 stores a device response program executed by the processor 21. The device response program may be a program for realizing at least one of the functions of the smart ECU 2. The execution of the device response program by the processor 21 corresponds to the execution of the position determination method.

The wireless communication module 24 is a short-range communication module built into the smart ECU 2. The wireless communication module 24 includes an antenna for the SRWC, a transmission and reception circuit, and an SRWC controller. The transmission and reception circuit is a circuit that performs signal processing related to modulation and demodulation. The SRWC controller is a microcomputer that executes data processing related to the SRWC.

The wireless communication module 24 is supplied with power from the vehicle battery even while the driving power supply is set to an off state. The wireless communication module 24 periodically scans using power supplied from the in-vehicle battery and attempts to connect to the user device 9. The scanning means being ready to receive an SRWC signal. Upon receiving the advertising signal from the user device 9, the wireless communication module 24 transmits a connection request to the user device 9 and establishes a communication connection with the user device 9. The wireless communication module 24 may be understood as an SRWC module that functions as a gateway for the user device 9 to communicate with the vehicle Hv. In the embodiments, the wireless communication module 24 is also referred to as a gateway module. The wireless communication module 24 may be disposed outside the smart ECU 2.

The in-vehicle communication unit 25 is a circuit that enables the processor 21 to communicate with each of the plurality of anchors 3. The in-vehicle communication unit 25 may also include a circuit that enables the processor 21 to communicate with other in-vehicle devices via an in-vehicle network. The in-vehicle communication unit 25 may include a PHY chip or the like that complies with the communication standard of the in-vehicle network.

The smart ECU 2 performs wireless authentication processing in the SRWC based on the establishment of a communication connection with the user device 9 using the wireless communication module 24. The wireless authentication process is a process of authenticating (in other words, verifying) the user device 9 via the wireless communication. The authentication may be performed in any manner, such as by a challenge-response method.

Upon establishing a communication connection with the user device 9, the smart ECU 2 causes each anchor 3 to perform distance measurement communication with the user device 9. The smart ECU 2 acquires data indicating the results of the distance measurement communication (hereinafter referred to as distance measurement result data) from each of the multiple anchors 3. The distance measurement result data includes the ID of the user device 9 that performed the distance measurement, data indicating the distance from the anchor 3 to the user device 9, and the reception strength of the device signal. In the embodiments, a value indicating the distance from the anchor 3 to the user device 9 determined by the distance measurement communication may be referred to as a distance measurement value.

The smart ECU 2 determines whether the user device 9 is disposed inside the vehicle, in a proximity area, or in a distant area based on the distance measurement value and the reception strength provided by each anchor 3. The proximity area is an area outside the vehicle that is disposed within a predetermined distance (for example, 1.5 meters) from the vehicle Hv. The distant area refers to an area outside the vehicle that is outside the proximity area. The method for determining the device position will be described in detail later.

The smart ECU 2 may be configured to calculate the device position coordinates by combining the distance measurements provided by multiple anchors 3. The device position coordinates refer to the position coordinates where the user device 9 is disposed in a two-dimensional or three-dimensional coordinate system based on a predetermined position of the vehicle Hv as the reference position. The calculation of the device position coordinates can be performed using a method similar to three-point positioning or multi-point positioning in the technical fields of GPS and position estimation.

As described above, each anchor 3 is a device for performing the distance measurement communication with a user device 9. The anchor 3 may have the same configuration and function as the wireless communication module 24. The anchor 3 is configured to be able to execute the SWRC (i.e., Bluetooth LE). The anchor 3 includes an antenna for the SWRC, a transmission and reception circuit, and an SRWC controller. Based on instructions from the smart ECU 2, the SRWC controller of the anchor 3 performs the distance measurement communication with the user device 9, generates the distance measurement result data, and transmits (or reports) the distance measurement result data to the smart ECU 2.

The distance measurement method using the Bluetooth LE may be CS (i.e., Channel Sounding) distance measurement. The CS distance measurement is a method of measuring the distance based on the difference in reception phase for each channel, which is obtained by transmitting and receiving CW (i.e., Continuous Wave) signals on multiple channels. The CS distance measurement is sometimes defined as High Accuracy Distance Measurement (i.e., HADM) or phase difference distance measurement. The anchor 3 may be configured to be able to transmit and receive a continuous wave (i.e., CW) signal with a predetermined waveform as a signal for distance measurement in addition to a modulation signal for the data communication. The waveform of the CW signal may be a sine wave or a triangular wave. A specific method for the CS distance measurement will be described later.

The distance measurement method may also be an RTT method that calculates the distance based on the round trip time (i.e., RTT). In the RTT method, the user device 9 measures the elapsed time from when the user device 9 transmits a poll signal to the anchor 3 until the user device 9 receives a response signal from the anchor 3 as the RTT. The user device 9 may calculate a distance measurement value from the RTT measured by performing the distance measurement communication and transmit the distance measurement value to the smart ECU 2 using the SRWC. The poll signal is a signal that requests the responder to return a response. The response signal may be referred to as an answer signal.

In the distance measurement communication of this embodiment, the user device 9 functions as an initiator, and the anchor 3 functions as a responder. The initiator is a device that takes the lead in the distance measurement communication. The division of roles in the distance measurement communication may be changed as appropriate. A plurality of anchors 3 may individually function as initiators to perform the distance measurement communication with the user device 9.

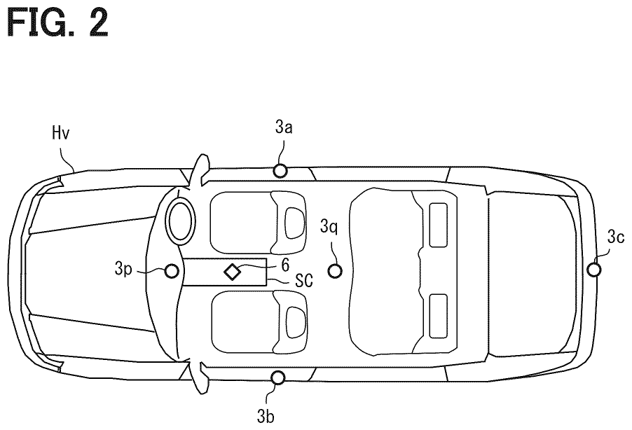

The in-vehicle system 1 may include multiple anchors 3. As shown in FIG. 2, the in-vehicle system 1 of the present embodiment includes anchors 3a, 3b, 3c, 3p, and 3q. The anchor 3a is an anchor 3 built into the outer door handle for the right front seat. The anchor 3a may be disposed on the right B-pillar, the right side mirror, the right side sill, or the right edge of the roof. The anchor 3a may be referred to as the right anchor or the first anchor. The anchor 3b is an anchor 3 built into the outer door handle for the left front seat. The anchor 3b may be disposed on the left B-pillar, the left side mirror, the left side sill, or the left edge of the roof. The anchor 3b may be referred to as the left anchor or the second anchor. The anchor 3c is an anchor 3 disposed in the center of the rear bumper, on the trunk door handle, or on the upper or lower edge of the rear window. The anchor 3c may be referred to as the rear anchor or the third anchor.

The anchors 3p and 3q are anchors 3 disposed inside the compartment of the vehicle. The anchor 3p is disposed in front of the anchor 3q in the compartment of the vehicle. The anchor 3p may be disposed on the instrument panel, the upper edge of the windshield, the center console, or the like. The anchor 3p may be referred to as the front compartment anchor or the fourth anchor. The anchor 3q is an anchor 3 disposed on the rear side of the anchor 3p inside the compartment of the vehicle. The anchor 3q may be disposed in a rearward position such as the center of the rear seat, the ceiling above the rear seat, or the trunk. The anchor 3q may be referred to as the rear compartment anchor or the fifth anchor. The mounting location of the anchor 3 described here is an example and may be changed as appropriate.

The anchors 3a to 3c are all attached to the outer surface of the vehicle Hv, and may be referred to as the outer units or the outer anchors. The anchors 3a to 3c correspond to the outside communication devices. The anchors 3p and 3q may be referred to as the inner units or the inner anchors since they are attached inside the compartment of the vehicle. The anchors 3p and 3q correspond to the inside communication devices. The anchor 3 is activated in response to an instruction from the smart ECU 2 and performs the distance measurement communication. The anchor 3 transitions to a power saving state based on an instruction from the smart ECU 2. The power saving state may be a state in which some or all functions are stopped in order to reduce power consumption. It should be noted that the wireless communication module 24 may also be used as the anchor 3. The wireless communication module 24 may be considered one of multiple inner anchors.

The in-vehicle display 4 is a display disposed inside the compartment of the vehicle. The in-vehicle display 4 displays an image in response to an instruction signal input from the smart ECU 2. The in-vehicle display 4 may be a liquid crystal display or an organic EL display. The in-vehicle display 4 may be configured to be able to display a plurality of colors.

The input device 5 is a device for receiving user instructions and operations for the in-vehicle system 1 (i.e., mainly the smart ECU 2). The input device 5 may be a touch panel stacked on the in-vehicle display 4. The user device 9 and the in-vehicle system 1 may be configured so that the user device 9 functions as the input device 5. The in-vehicle system 1 may include a plurality of types of devices as the input device 5.

The input device 5 outputs an operation signal, which is an electrical signal corresponding to a user's operation, to the smart ECU 2. The operation signal includes information indicating the content of the user's operation. The smart ECU 2 receives an instruction to register the communication characteristic of the user device 9 via the input device 5. In the present embodiments, a signal indicating that a registration operation for the communication characteristic of the user device 9 has been performed is also referred to as a registration instruction signal. The smart ECU 2 may display a characteristic registration guide image (which will be described later) on the in-vehicle display 4 based on the reception of the registration instruction signal.

The device detection unit 6 is a device that detects whether the user device 9 is placed in a predetermined position (hereinafter referred to as the inner set position) inside of the compartment of the vehicle. The inner set position may be a holder for the user device 9 provided on the center console SC or on the instrument panel.

The device detection unit 6 may be a device that detects the user device 9 based on the establishment of a communication connection with the user device 9 using a communication method within a communication distance of 0.1 meter or less. The device detection unit 6 may be a near field communication (NFC) module arranged in the inner set position. Here, the NFC refers to communication over a distance of several centimeters to several tens of centimeters. A specific standard for the NFC may be ISO/IEC 18092 (i.e., NFCIP-1), ISO/IEC 21481 (i.e., NFCIP- 2), ISO/IEC 14443, or ISO/IEC 18092. The smart ECU 2 may recognize that the user device 9 has been placed in the inner set position when the device detection unit 6 connects with the user device 9 via the NFC.

In another embodiment, the device detection unit 6 may be a wireless charger disposed in the inner set position. When the wireless charger starts supplying power to the user device 9, the smart ECU 2 may recognize that the user device 9 has been placed in a predetermined position in the compartment of the vehicle. The wireless charge method may be any method such as Qi or AirFuel Inductive/Resonant. Here, conversely, the location in the compartment of the vehicle where the wireless charger or the NFC module is disposed may be set to the inner set position.

Alternatively, the device detection unit 6 may be a device that detects that the user device 9 has been placed in a predetermined position inside the compartment of the vehicle by analyzing an image from a camera that captures the inside of the compartment of the vehicle. The device detection unit 6 outputs a signal to the smart ECU 2 indicating whether or not the user device 9 is placed in a predetermined position inside the compartment of the vehicle. The device detection unit 6 is an optional element and may be omitted. The device detection unit 6 may be considered as a type of in-vehicle sensor.

In addition to the above, various other in-vehicle devices may be directly or indirectly connected to the smart ECU 2. For example, the smart ECU 2 is connected to a power supply ECU, a cellular module, and vehicle body-related equipment so that they can communicate with each other via an in-vehicle network or using a dedicated cable. The power supply ECU is an ECU that controls the on and off state of the vehicle power supply. The vehicle power supply is a power supply that is turned on when the vehicle Hv is travelling. The cellular module is a communication module that implements cellular communication such as 4G or 5G. The vehicle body-related equipment includes headlights, door lock motors, and power window motors.

The smart ECU 2 controls the unlocking and locking state of the doors based on (i) the user device 9 being disposed in the proximity area, (ii) the user device 9 being authenticated, and (iii) a predetermined user action being taken. The user action for locking/unlocking may be touching the outside door handle or waving a foot over a detection area disposed below the door. The smart ECU 2 may be understood as an ECU that provides a passive entry function. The passive entry function is a function that locks/unlocks the vehicle Hv in response to a predetermined user action on the vehicle Hv.

The smart ECU 2 may be divided into multiple ECUs. For example, the smart ECU 2 may be divided into an ECU that determines the device position and an ECU that executes vehicle control such as unlocking. The functional layout within the in-vehicle system 1 may be changed as appropriate.

### User Device 9

The user device 9 may be a general-purpose information processing terminal equipped with the SRWC function. The user device 9 may be a smartphone or a wearable device. The user device 9 functions as a key to the vehicle Hv by performing wireless authentication using the smart ECU 2 and the SRWC. The user device 9 may be referred to as a mobile device, a key device, or the like. The user device 9 may be a dedicated device that functions as a wireless key for the vehicle Hv. The dedicated device may be called a smart key, a key fob, a key card, an access key, or the like.

The user device 9 of this embodiment has a rectangular shape, and has defined left, right, top and bottom directions. The user device 9 has edges corresponding to the four sides of the rectangular shape, which include a top edge, a bottom edge, a left edge, and a right edge.

The user device 9 includes a display device 91, an input device 92, an antenna 93, an RF (radio frequency) core 94, and a controller 95. The antenna 93 and the RF core 94 are electrically connected by a communication line or a conductor pattern. The display device 91, the input device 92, and the RF core 94 are connected to a controller 95 so as to be able to communicate with each other. The user device 9 may include a battery, a power receiving circuit for receiving power from a wireless charger, an NFC communication module, and the like.

The display device 91 is a device that displays an image according to a video signal input from the controller 95. The display device 91 may be a liquid crystal display, an organic EL display, or the like. The input device 92 is a device for receiving user instructions and operations for the user device 9. The input device 92 may be a touch panel stacked on the display device 91. The input device 92 outputs an operation signal, which is an electrical signal corresponding to a user's operation, to the controller 95. The operation signal includes information indicating the operation content of the user on the user device 9.

The controller 95 may be configured to receive an instruction to register the communication characteristic of the user device 9 in the smart ECU 2 via the input device 92. The controller 95 may be configured to cooperate with the in-vehicle system 1 to start a process of registering the communication characteristic of the user device 9 (hereinafter, characteristic learning process) based on receiving a registration instruction via the input device 92. The controller 95 may transmit an SRWC signal corresponding to a registration instruction signal to the smart ECU 2 based on receiving a registration instruction via the input device 92. The smart ECU 2 may be configured to be able to accept a registration instruction using an input device 92 (i.e., the user device 9).

The characteristic learning process may include displaying a characteristic registration guide image on the display device 91, the in-vehicle display 4, or both of them. The characteristic registration guide image is an image that shows the user the procedure for registering the communication characteristic of the user device 9 in the smart ECU 2. The characteristic registration guide image includes an image showing the location where the user device 9 should be placed and the orientation of the user device 9 when registering the communication characteristic. The characteristic registration guide image may include multiple patterns and/or images. Hereinafter, the in-vehicle display 4 and the display device 91 will also be collectively referred to as a display. The display in the following may be understood as the vehicle display 4 or the display device 91, or both of them.

The antenna 93, the RF core 94, and the controller 95 correspond to a configuration for implementing the SRWC. The antenna 93, the RF core 94, and the controller 95 may be mounted on a single circuit board. The antenna 93 is an antenna element for transmitting and receiving radio waves in the frequency band (for example, 2.4 GHz band) to be used for the SRWC.

The RF core 94 is a circuit module that performs processing related to the transmission and reception of radio signals. The RF core 94 may include a modulation circuit, a demodulation circuit, a frequency conversion circuit, an amplification circuit, a local oscillator, and the like. The RF core 94 is connected to the antenna 93 and the controller 95. The RF core 94 demodulates the signal received by the antenna 93 and provides it to the controller 95. The RF core 94 also modulates transmission data input from the controller 95 and emits the modulated data as radio waves from the antenna 93. The RF core 94 may be realized as an IC chip (i.e., a transmission and reception IC).

Similar to the anchor 3, the RF core 94 is configured to be able to transmit and receive CW signals for each channel as distance measurement signals. The RF core 94 provides the controller 95 with reception phase information and reception strength for each channel. In this embodiment, the controller 95 generates a distance measurement value based on reception phase information for each channel, alternatively, the functional arrangement within the user device 9 is not limited to this feature. The RF core 94 may be configured to calculate the distance measurement value based on the reception phase information for each channel.

The controller 95 is a microcomputer that controls the overall operation of the user device 9. The controller 95 includes a processor E1, a memory E2, a storage E3, and a communication interface E4. The processor E1 may be a CPU. The memory E2 is a volatile storage medium such as a RAM. The storage E3 is a storage device that includes a non-volatile storage medium such as a flash memory. The storage E3 may include multiple types of storage media, such as a ROM (Read Only Memory) and a flash memory. The communication interface E4 is a circuit module that allows the processor E1 to communicate with other components such as the display device 91, the input device 92, the RF core 94, and the like.

The storage E3 stores a device control program. The device control program is a program that includes instructions related to the device characteristic learning process. Furthermore, the communication data is stored in the storage E3. The communication data is data for performing the wireless communication with the vehicle Hv. The communication data may include parameters received from the smart ECU 2 through a pairing operation, such as the device ID of the smart ECU 2. The communication data may also include the identification number of the vehicle Hv (hereinafter referred to as vehicle ID). The vehicle ID corresponds to identification information of the vehicle and/or the in-vehicle system to be communicated with. The vehicle ID may be referred to as the system ID. The vehicle ID may be a Vehicle Identification Number (VIN). The communication data may include a key code used for the wireless authentication with the vehicle Hv.

The controller 95 is configured to periodically advertise using the RF core 94 and the antenna 93. The advertising is a process of transmitting an advertising signal using a predetermined channel. An advertising signal is a radio signal used to notify other devices of its presence. When the controller 95 receives a connection request from the vehicle Hv in response to the advertisement, the controller 95 establishes a communication connection with the vehicle Hv. The controller 95 can perform the authentication processing (i.e., the wireless authentication) using the SRWC based on the establishment of a communication connection with the vehicle Hv.

### Position Determination Overview

If the user device 9 is disposed away from the vehicle Hv (i.e., outside the SRWC area), the smart ECU 2 cannot connect to the user device 9 via the SRWC. When the smart ECU 2 is not connected to the user device 9 via the SWRC, the smart ECU 2 sets the anchor 3 to a sleep state and does not perform the position determination. When the smart ECU 2 is not connected to the user device 9 for communication, the smart ECU 2 periodically scans the user device 9 to search for the user device 9. When the user device 9 is not connected to the smart ECU 2 for communication, the user device 9 periodically transmits an advertising signal.

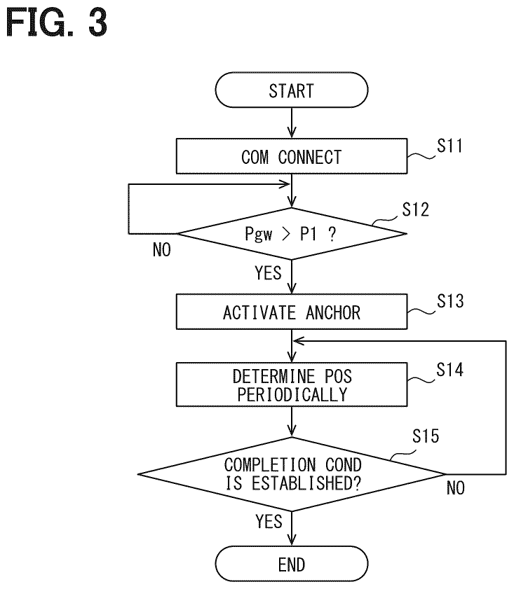

When the user device 9 enters the SRWC area of the vehicle Hv as the user moves, the smart ECU 2 can receive an advertising signal from the user device 9. Upon receiving the advertising signal from the user device 9, the smart ECU 2 transmits a connection request signal to the user device 9. As a result, the user device 9 and smart ECU 2 transition to a communication connection state (at S11 in FIG. 3). The communication connection state may be understood as a state in which an SRWC link is established. The connection request signal is a signal that requests a communication connection.

In the communication connection state, the smart ECU 2 and the user device 9 transmit and receive wireless signals for communication confirmation or perform encrypted data communication at predetermined intervals (for example, connection intervals). Accordingly, the smart ECU 2 periodically acquires the reception strength of the device signal from the wireless communication module 24.

The smart ECU 2 keeps the anchor 3 in a sleep state until the reception strength of the device signal exceeds a predetermined activation strength (“NO” at S12). Also, if the communication connection between the user device 9 and the smart ECU 2 is cut off without the reception strength exceeding the activation strength, this flow may be ended.

If the reception strength of the device signal exceeds a predetermined activation strength (“YES” at S12), the smart ECU 2 activates all anchors 3 and causes the anchors 3 to perform the distance measurement communication with the user device 9 (at S13). Thereafter, the position determination process is periodically executed until the completion condition is met (at S14). The position determination process includes the anchor 3 conducting the distance measurement communications with the user device 9.

The activation strength used in step S12 is a threshold value related to the reception strength for starting the distance measurement communication. The activation strength may be determined based on the reception strength of an SRWC signal transmitted from a predetermined reference device placed at a predetermined position outside the vehicle, for example. For example, the activation strength may be set based on the reception strength observed by the wireless communication module 24 when the reference device is placed at a point of 10 meters away from the vehicle Hv.

The reference device means the device used to determine the threshold for reception power for determining the device position. The reference device may be any model of iPhone (registered trademark) or Android (registered trademark) device. The reference device may be any of a variety of user devices 9 that are commonly available commercially. The user device 9 used as the reference device can be selected by the designer of the position determination system. The activation strength may be set based on the reception strength observed when the reference device and the smart ECU 2 actually communicate as a test.

The completion condition may be the disconnection of the communication connection between the smart ECU 2 and the user device 9. Alternatively, the smart ECU 2 may determine that the completion condition is met when the traveling speed of the vehicle Hv becomes equal to or greater than a predetermined value. If the completion condition is met (“YES” at S15), the smart ECU 2 transitions all anchors 3 to a sleep state and terminates the periodic position determination.

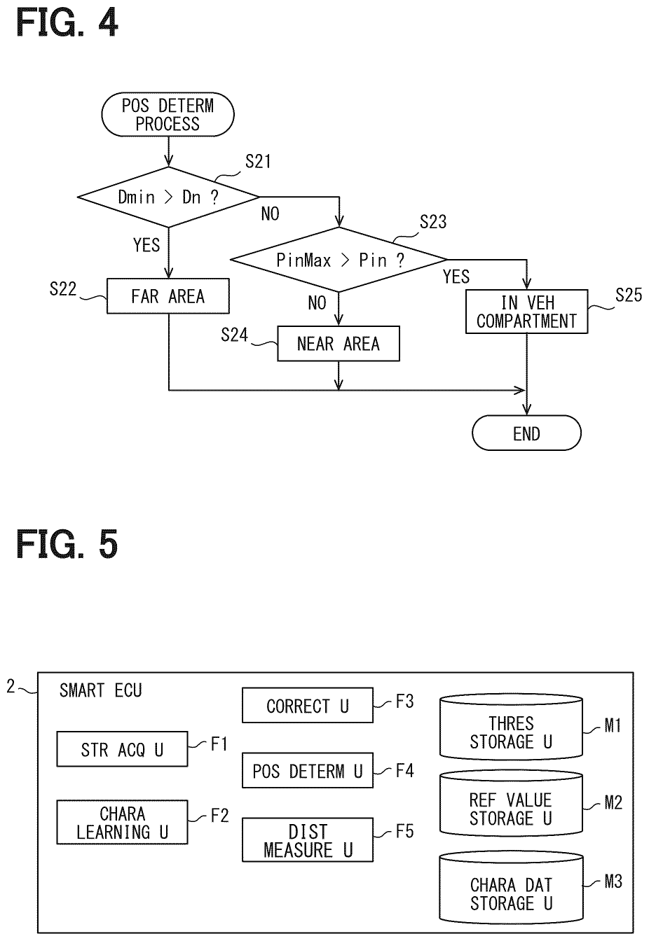

The device position may be determined using both the distance measurement value and the reception strength as shown in FIG. 4. The reception strength used in the following description may be understood as a strength value corrected using characteristic data, which will be described later. The position determination process includes determining whether or not the minimum observation distance obtained as a result of the distance measurement communication exceeds a predetermined proximity determination distance (at S21). If the minimum observation distance obtained as a result of the distance measurement communication exceeds a predetermined proximity determination distance (“YES” at S21), the smart ECU 2 may determine that the user device 9 is disposed in a distant area (S22).

The minimum observation distance means the minimum value of the distance measurement values observed by multiple anchors 3. “Dmin” in FIG. 4 represents the minimum observation distance. Also, “Dn” represents the proximity determination distance. The proximity determination distance is a parameter that defines the proximity area outside the vehicle. The proximity determination distance may be set to, for example, 1.0 meter, 1.5 meters, or 2 meters. The proximity area can be understood as an area in which automatic unlocking/locking of the vehicle Hv can be performed. The proximity area may be rephrased as a passive entry area.

On the other hand, if the minimum distance measurement value (Dmin) is equal to or less than the proximity determination distance (Dn), the smart ECU 2 determines whether the inner maximum strength value exceeds a predetermined inner determination value (at S23). The inner maximum strength value here means the maximum value of the reception strength observed at the inner anchor. “PinMax” in the drawings represents the inner maximum strength value. In addition, “Pin” in the drawings represents the inside compartment determination strength.

If the minimum observation distance is less than the proximity determination distance and the inner maximum strength value does not exceed the predetermined inside compartment maximum strength value (“NO” at S23), the smart ECU 2 may determine that the device position is in the proximity area (at S24). On the other hand, if the minimum observation distance is less than the proximity determination distance and the inner maximum strength value exceeds the predetermined inner determination strength value (“YES” at S23), the smart ECU 2 may determine that the device position is inside the compartment of the vehicle (at S24).

The inner determination strength is a threshold value related to the reception strength for determining that the user device 9 is inside the compartment of the vehicle. The inner determination strength may be determined based on the reception strength at the inner anchor of the SRWC signal transmitted from a reference device placed at an inner set position inside the compartment of the vehicle. The inside compartment determination strength may be pre-established by testing with a reference device.

Here, the method of determining the device position shown in FIG. 4, in other words, the determination method described above, is merely an example and is not limited to the above feature. The condition for determining that the user device 9 is inside the compartment of the vehicle (hereinafter referred to as the inner compartment determination condition) may include that the inner/outer strength difference, which is the value obtained by subtracting the maximum inner strength from the maximum outer strength, is greater than or equal to a predetermined strength difference threshold (e.g., 10 dB). The maximum outer strength here means the maximum value of the reception strength observed at multiple outer anchors. The inside compartment determination condition may also include a condition that the minimum inner distance value, which is the minimum value of the distance measurement values at the inner anchor, is less than a predetermined inner determination distance (for example, 1.0 meter).

The condition for determining that a device position is disposed within the proximity area (hereinafter, the proximity determination condition) may also be changed as appropriate. The proximity determination condition may include that the maximum outer strength is equal to or greater than a predetermined proximity determination strength. The proximity determination strength may be set based on the results of a reception strength observation test using a reference device.

The above-mentioned various parameters for determining the device position (hereinafter referred to as position determination parameters) may be registered in the storage 23 of the smart ECU 2. The position determination parameters include some or all of the activation strength, the inside compartment determination strength, the strength difference threshold, the proximity determination strength, the proximity determination distance, and the inside compartment determination distance.

### Issues Related to Position Determination Accuracy

The mobile devices that can be user devices 9, such as smartphones, tablets, and wearable devices, can be manufactured by multiple manufacturers. The strength and directionality of the SRWC signal transmitted by the user device 9 may vary depending on the manufacturer and model of the user device 9. This is because the antenna configuration and transmission power settings and the like vary depending on the manufacturer and model of the user device 9.

Furthermore, even if the user devices 9 are of the same model, the communication characteristic may differ due to manufacturing variations. The communication characteristics here may be interpreted as the directivity or the transmission characteristic. Furthermore, the communication characteristic of the user device 9 may be affected by an attachment to the user device 9, such as a cover. In this way, the communication characteristic may differ for each user device 9. In an assuming configuration where the device position is determined by comparing the actual reception strength of the signal from the user device 9 with a threshold designed on a reference device, the device position may be determined incorrectly. For this reason, the smart ECU 2 of this embodiment is provided with a mechanism for learning the difference in the communication characteristic between the user device 9 and the reference device, and using the learning result for position determination.

### Function of Smart ECU

As shown in FIG. 5, the smart ECU 2 includes functional blocks including a strength acquisition unit F1, a characteristic learning unit F2, a correction unit F3, a position determination unit F4, and a distance measurement unit F5. Some or all of these functional blocks may be realized by the processor 21 executing a device control program. The smart ECU 2 includes a reference value storage unit M1, a threshold value storage unit M2, and a characteristic data storage unit M3. These storage units may be realized using the storage area provided in the storage E3. The reference value storage unit M1, the threshold value storage unit M2, and the characteristic data storage unit M3 may be implemented in the same storage medium, or some of them may be implemented in different storage media. The smart ECU 2 may be configured to be able to access the reference value storage unit M1, the threshold value storage unit M2, and the characteristic data storage unit M3 and to read, write, or delete data. The smart ECU 2 corresponds to the control unit.

The reference value storage unit M1 is a storage medium and area in which data indicating the communication characteristic of a reference device is stored. The data indicating the communication characteristic of the reference device includes data of the reception strength observed at the inner anchor when the reference device is disposed inside the compartment of the vehicle. The data indicative of the communication characteristic of the reference device includes data of the reception strength observed at the outer anchor when the reference device is disposed in the proximity area.

In this embodiment, the data indicating the communication characteristic of the reference device includes an inner reference value and an outer reference value. The inner reference value may be the average value of the reception strength of the SRWC signal from the reference device observed at multiple inner anchors when the reference device is disposed in the inner set position. In another example, the inner reference value may be the reception strength of the SRWC signal from the reference device detected by a specific anchor 3 when the reference device is disposed in the inner set position. The specific anchor 3 may be, for example, an anchor 3p or a wireless communication module 24.

The outer reference value may be the maximum value of the reception strength of the SRWC signal from the reference device observed at multiple outer anchors when the reference device is disposed at a predetermined outer set position. The outer set position is a predetermined measurement position outside the vehicle. The outer set position may be 1.5 meters to the right of the outside door handle for the right front seat of the vehicle. In other embodiments, the outer set position may be 0.1 meters from the outside door handle or the bottom edge of the side window for the right front seat of the vehicle. The reception strength used to determine the outer reference value may be the reception strength of the direct wave (hereinafter referred to as the direct wave strength). The direct wave refers to the SRWC signal transmitted from the mobile device and reaching the anchor 3 without being reflected by other objects. Generally, the reflection wave has a longer propagation path than the direct wave. Therefore, the direct wave is received by the anchor 3 earlier than the reflection wave. The anchor 3 may report the strength of the device signal that the anchor 3 receives first in one distance measurement communication to the processor 21 as the strength of the direct wave. The anchor 3 may receive a signal in which a reflection wave is superimposed on a direct wave over time. The anchor 3 may extract a direct wave from the reception signal by digital signal processing such as the MUSIC method or the ESPRIT method, and obtain its reception strength. The direct wave can be rephrased as a first path.

In another example, the outer reference value may be the reception strength of the SRWC signal from the reference device detected by a specific outer anchor when the reference device is disposed in the outer set position. The specific outer anchor may be the anchor 3 (i.e., anchor 3a) that is closest to the outer set position.

The reference value storage unit M1 may store a gateway reference value in addition to the inner and outer reference values. The gateway reference value is the reception strength of the signal from the reference device detected by the wireless communication module 24 when the reference device is disposed at the outer set position. The gateway reference value may be understood as a parameter on which the activation strength is determined based. The various reference values correspond to assumption values of the reception strength of the signal transmitted from the reference device.

The threshold storage unit M2 is a storage medium and area in which parameters for the position determination, such as activation strength and inside compartment determination strength, are stored. The position determination parameter relating to the reception strength may be set based on an inner reference value or an outer reference value.

The characteristic data storage unit M3 is a storage medium and area in which data indicating the difference in the communication characteristic between the user device 9 and the reference device is stored. The difference in the communication characteristic may be understood as a difference in the signal strength (in other words, the reception strength). The data indicating the difference in the communication characteristic may be a correction value γ. When the reception strength of the SRWC signal from a reference device observed under the same conditions (hereinafter referred to as the reference value) is defined as α and the reception strength of the device signal (i.e., the observation value) is defined as β, the correction value γ may be expression as an expression of “γ=β−α”.

The characteristic data storage unit M3 stores, for example, an inner correction value γ1, which is a value for correcting the reception strength observed at the inner anchor. The inner correction value γ1 may be a value obtained by subtracting the reference value α1 from the measurement value β1. The reference value α1 may be an inner reference value. The measurement value β1 may be the average value of the reception strength detected at multiple inner anchors when the user device 9 is disposed at the inner set position. The measurement value β1 may be the reception strength of a device signal detected by a predetermined anchor 3. The inner correction value γ1 corresponds to a correction value assuming that the user device 9 is disposed inside the compartment of a vehicle.

In addition to the inner correction value γ1, an outer correction value γ2 may be registered in the characteristic data storage unit M3. This outer correction value γ2 is a value used to correct the reception signal strength observed at the outer anchor. The outer correction value γ2 is a correction value assuming that the user device 9 is disposed outside the vehicle. The outer correction value γ2 may be a value obtained by subtracting the reference value α2 from the measurement value β2. The reference value α2 may be an outer reference value. The measurement value β2 may be the maximum value of the direct wave strength detected at multiple outer anchors when the user device 9 is disposed in the outer set position. The reference value α2 and the measurement value β2 may be the direct wave strength observed at a specific outer anchor when the reference device and the user device 9 are disposed in the outer set position. The specific outer anchor may be the anchor 3 (i.e., anchor 3a) that is closest to the outer set position.

The characteristic data storage unit M3 may store a gateway correction value. The gateway correction value may be a value obtained by subtracting the gateway reference value from the device signal detected by the wireless communication module 24 when the user device 9 is disposed at the outer set position. The gateway correction value can be used to correct the reception strength or the activation strength used in the determination in step S12. The data stored in the characteristic data storage unit M3 is updated by the characteristic learning unit F2. A data set indicating the communication characteristic for one user device 9 is also referred to hereinafter as characteristic data. The characteristic data may be understood as the data including various correction values such as an inner correction value. The characteristic data may be referred to as correction data or difference data. The various correction values and the calculation methods thereof described above are merely examples. The type of the correction value generated by the smart ECU 2 and the calculation method thereof may be changed as appropriate.

The strength acquisition unit F1 is configured to acquire data indicating the reception strength of the device signal from the wireless communication module 24 and the anchor 3. The reception strength data acquired by the strength acquisition unit F1 is temporarily stored in the memory E2. The reception strength data stored in the memory E2 is referenced by the characteristic learning unit F2, the correction unit F3, and the position determination unit F4.

The characteristic learning unit F2 is configured to generate characteristic data of the user device 9 and store it in the characteristic data storage unit M3. The characteristic learning unit F2 acquires the characteristic data such as an inner correction value by executing a characteristic learning process described later. The characteristic data may be stored in association with the device ID of the user device 9. The characteristic learning unit F2 may be configured to be able to store the characteristic data of multiple user devices 9 in the characteristic data storage unit M3. The device characteristic data for each user device 9 may be distinguished using a device ID or the like.

The correction unit F3 is configured to correct the reception strength acquired by the strength acquisition unit F1 using the characteristic data stored in the characteristic data storage unit M3. The correction unit F3 corrects the reception strength observed at the inner anchor with the inner correction value. For example, when the reception signal strength detected by the inner anchor is defined as ρ1, the correction unit F3 corrects the reception signal strength by an expression of “ρ1−γ1”. For convenience, the corrected reception strength is also referred to as the corrected strength. Here, ρ1 may be the maximum inner strength. The correction unit F3 may be configured to correct each of the reception strength observed at a plurality of inner anchors.

The correction unit F3 may correct the reception strength observed at the outer anchor with an outer correction value. For example, when the reception signal strength detected by the outer anchor is defined as ρ2, the correction unit F3 corrects the reception signal strength by an expression of “ρ2−γ2”. Here, ρ2 may be the maximum outer strength. The correction unit F3 may be configured to correct each of the reception strength observed at a plurality of outer anchors.

The correction unit F3 may use the gateway correction value to correct the reception strength used to determine the activation of the anchor 3. The reception strength used to determine whether the anchor 3 is activated is the reception strength at the wireless communication module 24. In the embodiments, the reception strength of the device signal detected by the wireless communication module 24 is also referred to as gateway strength. The corrected gateway strength may be the value obtained by subtracting the gateway correction value from the gateway strength.

The position determination unit F4 is configured to determine the device position based on the corrected reception strength and the distance measurement value. The distance measurement unit F5 is configured to control the distance measurement communication between the anchor 3 and the user device 9. The distance measurement unit F5 activates the anchor 3 based on the feature that the uncorrected gateway strength exceeds the activation strength, and causes the anchor 3 to perform the distance measurement communication with the user device 9.

### Example of mobile device operation

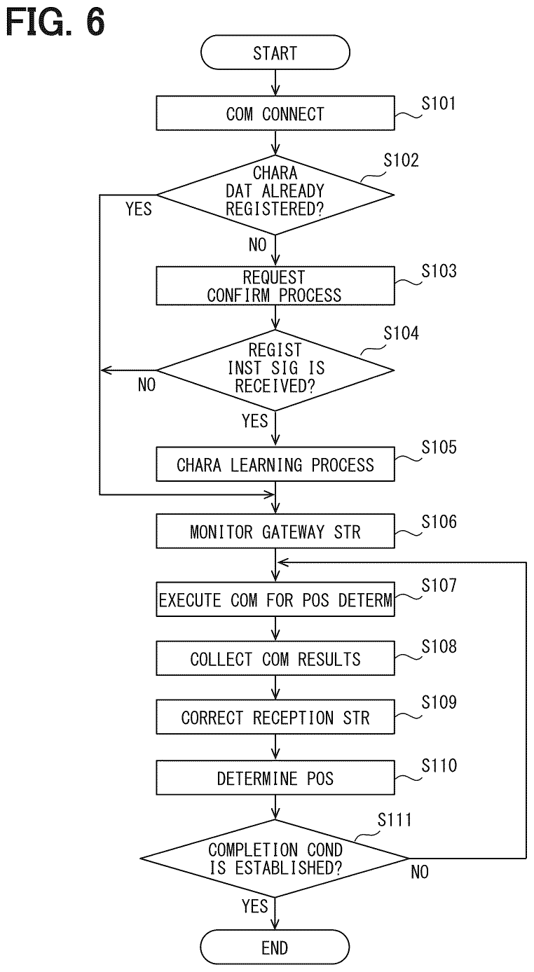

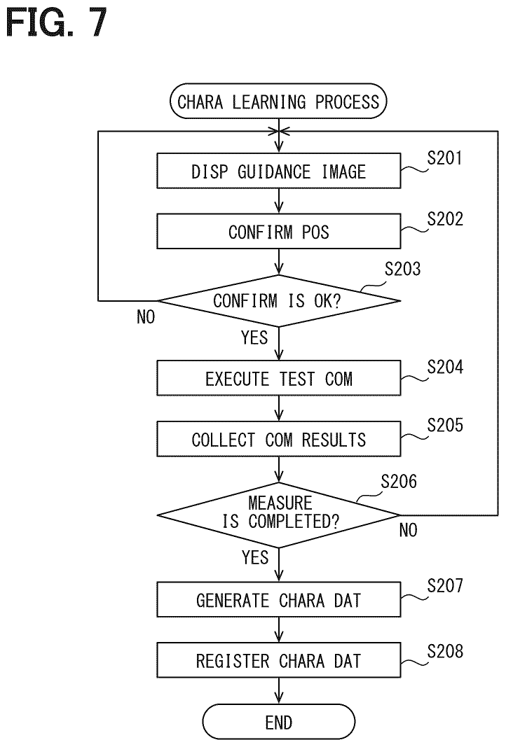

Here, the operation of the smart ECU 2 will be described with reference to the flowcharts shown in FIGS. 6 and 7. The flow shown in FIG. 6 corresponds to a flow in which the characteristic learning process and the reception strength correction process are incorporated into the position determination process described with reference to FIGS. 3 and 4. The series of processes shown in FIG. 6 can be called position determination-related processes. The position determination related processes may include steps S101 to S111 as shown in FIG. 6. In the following flow description, the term “processor 21” may be replaced with the smart ECU 2, the strength acquisition unit F1, the characteristic learning unit F2, the correction unit F3, the position determination unit F4, or the distance measurement unit F5.

The flow shown in FIG. 6 may start when the wireless communication module 24 receives an advertising signal from the user device 9. Step S101 is a step of transmitting a connection request signal to the user device 9 and establishing a communication connection with the user device 9. In step S102, the processor 21 determines whether the characteristic data of the user device 9 with which the smart ECU 2 is connected for the communication is stored in the characteristic data storage unit M3. A case in which the characteristic data of the user device 9 is not stored in the characteristic data storage unit M3 may be, for example, a case in which the position determination process is performed for the first time after the smart ECU 2 and the user device 9 are paired. When a user uses a vehicle that the user has never used before for the first time in a car sharing service or the like, the characteristic data may not be stored.

If the characteristic data of the user device 9 is not stored in the characteristic data storage unit M3, a negative determination is made in step S102 and the process proceeds to step S103. On the other hand, if the characteristic data of the user device 9 is stored in the characteristic data storage unit M3, an positive determination is made in step S102 and the process proceeds to step S106. Note that even if a certain period of time has elapsed since the characteristic learning process was last performed, a positive determination may be made in step S102, and steps S103 to S105 may be performed.

Step S103 is a step in which the processor 21 executes a request confirmation process. The request confirmation process is a process of inquiring of the user as to whether or not to register the characteristic data of the user device 9 in the smart ECU 2 (i.e., the vehicle Hv). The request confirmation process may include displaying on the display an image (hereinafter, request confirmation screen) including a message inquiring whether or not to register the characteristic data in the vehicle Hv. The processor 21 acquires the result of the request confirmation process, that is, the user's response indicating whether or not to register the characteristic data in the vehicle, via the input devices 5 and 92. Based on a user operation, the input device 5, 92 transmits to the processor 21 a response signal indicating that the characteristic data is to be registered in the vehicle. This response signal corresponds to a registration instruction signal.

If the processor 21 receives a registration instruction signal (“YES” at S103), the processor 21 executes step S104. On the other hand, if the processor 21 does not receive a registration instruction signal as a result of the request confirmation process (“NO” at S103), the process proceeds to step S106.

Step S105 is a step for executing a characteristic learning process. The characteristic learning process includes steps S201 to S208 as shown in FIG. 7. In the embodiments, steps S201 to S206 are also referred to as a strength measurement process. The strength measurement process may include multiple in-vehicle anchors simultaneously and/or sequentially measuring the reception strength of device signals for each frequency. The strength measurement process may include an inner strength measurement process and an outer strength measurement process. The inner strength measurement process is a process of measuring the reception strength of the device signal when the user device 9 is disposed in the inner set position. The outer strength measurement process is a process of measuring the reception strength of the device signal when the user device 9 is disposed outside the vehicle (for example, at an outer set position).

Step S201 is a step of displaying a characteristic registration guide image on a display. The characteristic registration guide image may include an image indicating placing the user device 9 in the initial set position. The initial set position refers to the position to which the user device 9 should be initially set among a plurality of set positions preset in the smart ECU 2. In this embodiment, the initial set position is the inner set position. In other embodiments, the initial set position may be an outer set position.

The characteristic registration guide image may include a set completion button. The set completion button is a button for inputting to the smart ECU 2 that the user device 9 has been placed in the specified set position. Step S201 may include outputting a voice message for guiding the user device 9 to place the user device 9 in the inner set position. After step S201 is executed, the process proceeds to step S202. The set position at which the processor 21 requests the user to place the user device 9 using voice or image is also referred to as a designation position in the embodiments.

Step S202 is a step in which the processor 21 confirms that the user device 9 has been placed at the designation position. The designation position here may be understood as the inner set position. The placement of the user device 9 at the designation position may be confirmed based on the user operations on the input devices 92 and 5. The processor 21 may determine that the user device 9 has been placed in the specific position based on the user pressing the set completion button. The processor 21 may determine whether the user device 9 has been placed at the designation set position based on the distance measurements observed at multiple anchors 3. If the position of the user device 9 estimated from the distance measurement value deviates from the specific set position, the processor 21 may display an image on the display requesting the user to adjust the position of the user device 9. Additionally, the processor 21 may confirm that the user device 9 has been placed in the inner set position based on a signal from the device detection unit 6.

If the processor 21 confirms that the user device 9 has been placed in the designation position (“YES” at S203), it proceeds to step S204. If it cannot be confirmed that the user device 9 has been placed in the designation position (“NO” at S203), the processor 21 may re-display the characteristic registration guide image. If the processor 21 cannot confirm that the user device 9 has been placed in the specific position even after a certain period of time has elapsed since the display of the characteristic registration guide image, it may interrupt the characteristic learning process and execute step S106.

Step S204 is a step of executing test communication. The test communication may be a communication for each anchor 3 to observe the reception strength of the device signal. The test communication may include having each anchor 3 observe (or sniffer) on the communication between the wireless communication module 24 and the user device 9. The test communication may include multiple anchors 3 individually conducting the SRWC with the user device 9. The test communication may include the anchor 3 detecting the reception strength of each channel by switching between channels in sequence. The test communication may also be a distance measurement communication between the user device 9 and the anchor 3. When the test communication is completed, the process proceeds to step S205.

Step S205 is a step in which the processor 21 collects the communication results from the anchors 3. For example, the processor 21 may receive the reception strength for each channel from each anchor 3 as a communication result. The communication result may include a distance measurement value. The communication result is stored in the memory 22 in association with data indicating the measurement conditions. The measurement conditions indicate the position of the user device 9 when the test communication is performed. The measurement conditions may include the orientation of the user device 9 when the test communication is performed. Hereinafter, the orientation of the user device 9 may also be referred to as the device orientation. When step S205 is completed, the process proceeds to step S206.

Step S206 is a step for determining whether or not the strength measurement processing has been completed under all planned measurement conditions. The characteristic learning process may include a step of causing a plurality of anchors 3 to detect the reception strength of the device signal under a plurality of measurement conditions in which the position or orientation of the user device 9 is different.

If the strength measurement process has not been completed under all measurement conditions (“NO” at S206), the process returns to step S201, and the processor 21 may display a characteristic registration guide image to perform the strength measurement process under unmeasured conditions. For example, if the inner strength measurement process is completed and the outer strength measurement process is not completed, the processor 21 may change the designation position to the outer set position and then perform steps S201 to S205.

The strength measurement process at the outer set position may include observing the reception strength when the user device 9 is placed at the outer set position in different orientations. For example, the characteristic learning process may include collecting reception strength when the user device 9 is placed in the outer set position in the first to fifth orientations. The first orientation may be an orientation in which the screen of the user device 9 is horizontal and the upper end of the user device 9 is directed toward the vehicle Hv. The second orientation may be an orientation in which the screen of the user device 9 is horizontal and the bottom end of the user device 9 is directed toward the vehicle Hv. The third orientation may be an orientation in which the screen of the user device 9 is horizontal and the left edge of the user device 9 is directed toward the vehicle Hv. The fourth orientation may be an orientation in which the screen of the user device 9 is horizontal and the right edge of the user device 9 is directed toward the vehicle Hv. The fifth orientation may be an orientation in which the screen or the back of the user device 9 faces the vehicle Hv. The first to fifth orientations applied in the outer strength measurement process may be called outer first to fifth orientations. The orientations may be different from each other. The combination of device orientations for which the test communication should be performed in the outer strength measurement process may be only the first to fourth orientations, or may be only the first and fifth orientations. The combination of device orientations in which the test communication should be performed may be designed as appropriate.

Furthermore, the outer set position is not limited to one location. The smart ECU 2 may be set with a first outer set position and a second outer set position. The first outer set position may be disposed within 0.1 meters of the center of the driver's side window. The second outer set position may be disposed at 1.5 meters to the side of the driver's outer door handle. The processor 21 may perform the strength measurement process in the order of the inner set position, the first outer set position, and the second outer set position.

The orientation of the user device 9 in the first outer set position may be such that the screen faces the compartment of the vehicle. The measurement orientation at the first outer set position may be one pattern or may be a plurality of patterns. The measurement orientation at the second outer set position may be one of the five patterns of the first to fifth orientations described above, or may be one of the four patterns of the first to fourth orientations.

If the strength measurement process has been completed under all conditions (“YES” at S206), the process proceeds to step S207. Step S207 is a step in which the processor 21 generates the characteristic data based on the reception strength data collected in the above process. As described above, the processor 21 generates various correction values based on the difference between the reference value α and the measurement value β observed under the same conditions.

The measurement value β1 used to calculate the inner correction value may be the average value of the reception strength for each channel detected by multiple inner anchors when the user device 9 is placed in the inner set position. In the embodiments, the average value of the reception strength for each channel is also referred to as the average strength value at multiple frequencies or the average frequency value. If there are three inner anchors and the reception strength is observed on 10 channels, β1 may be the average value of 30 reception strength samples. The reference value α2 and the measurement value β2 used to calculate the outer correction value may be the maximum value of the direct wave strength for each channel and each outer anchor.

The above steps S201-S205 may be designed to collect data to generate the desired correction values. Step S206 may be a step of performing a predetermined calculation process on the reception strength data collected in steps S201 to S205 so as to generate a correction value according to the method of determining the device position. The calculation process may include excluding outliers, calculating average values, subtracting values, and the like.

When the generation of the characteristic data is completed, the process proceeds to step S207. Step S207 is a step of storing the characteristic data generated in step S206 in the characteristic data storage unit M3.

When the above characteristic learning process is completed, the process proceeds to step S106 in FIG. 6. In the characteristic learning process, the set positions for which the strength measurement process is performed may be only the inner set positions or the outer set positions. The combination of locations where the user devices 9 are placed may be changed as appropriate depending on the correction values to be generated. The correction value to be generated in the characteristic learning process may be configured to be selectable by the user in the request confirmation process.

Step S106 is a step in which the processor 21 monitors the gateway strength. Step S106 corresponds to the above-mentioned step S12. If the characteristic data is stored in the characteristic data storage unit M3, step S106 may include the processor 21 correcting the reception strength (i.e., the gateway strength) detected by the wireless communication module 24 with the gateway correction value. The gateway strength to be compared to the activation strength may be the corrected gateway strength. The processor 21 executes step S107 based on the feature that the corrected gateway strength is equal to or greater than the activation strength. When the characteristic data is stored in the characteristic data storage unit M3, the gateway strength to be compared with the activation strength may be an uncorrected value.

Step S107 is a step of executing the communication for determining the position. The communication for determining the position may be the distance measurement communication between each anchor 3 and the user device 9. Step S107 may include activating the anchor 3. Step S107 may include the smart ECU 2 exchanging the distance measurement communication settings with the user device 9 via the SRWC. The settings for the distance measurement communication include the interval at which the distance measurement communication is performed. As will be described later, step S107 is executed periodically until a predetermined termination condition is satisfied. The processor 21 executes step S108 every time it executes step S107.

Step S108 is a step in which the processor 21 acquires the results of the distance measurement communication, such as the reception strength and the measurement distance, from each anchor 3. When step S108 is completed, the process proceeds to step S109. Step S109 is a step of correcting the collected reception strength with the characteristic data. Step S109 may include correcting the reception power observed at the outer anchor with an outer correction value. Step S109 may also include correcting the reception signal strength observed at the inner anchor with the inner correction value. Step S109 may include correcting the maximum outer strength and/or the maximum inner strength.

When step S109 is completed, the process proceeds to step S110. Step S110 is a step for determining the device position using the corrected maximum inner strength value and the corrected maximum outer strength value. The outline of step S110 may be the same as that described with reference to FIG. 4. When step S110 is completed, the process proceeds to step S111. If no characteristic data is registered at the time step S110 is executed, the processor 21 may perform the position determination using uncorrected reception strength. Examples of cases where the characteristic data is not registered at the time step S110 is executed include when the characteristic registration process fails and when a registration instruction signal is not received as a result of the request confirmation process (“NO” at S103).

Step S111 is a step for determining whether or not a termination condition is met. Step S111 corresponds to S15. If the termination condition is met, the processor 21 puts the anchor 3 to sleep. The processor 21 repeatedly executes steps S107 to S111 until the termination condition is satisfied.

The processor 21 may execute processing according to a user action based on the latest determination result of the device position. For example, when the processor 21 determines that the device position is disposed in the proximity area and detects a user's unlocking operation, the processor 21 unlocks the door. of the vehicle If the execution function of vehicle control is provided in an ECU other than the smart ECU 2, the smart ECU 2 may periodically transmit data including the device position determination result and the device ID, and the user information to the other ECU.

### Effects

The smart ECU 2 generates the characteristic data indicating the difference in the communication characteristic between the user device 9 used by the user and a reference device by communicating with the actual user device 9. The smart ECU 2 also determines the device position using the reception strength of the device signal corrected using the characteristic data. Therefore, it is possible to reduce the risk of erroneous determination of the device position due to differences in the communication characteristic between the user device 9 and the reference device.

The inner correction value is calculated based on the average value of the reception strength observed at multiple inside compartment anchors. Based on the test results, the inventors of the present disclosure have found that because the inside of a compartment of the vehicle is a multipath environment, the orientation of the user device 9 is unlikely to affect the average value of the reception strength at multiple anchors 3. A configuration in which the correction value is determined based on the average value of the reception strength observed at a plurality of inside compartment anchors can reduce the effect of the device orientation on the correction value.

Furthermore, different frequencies may have different propagation paths. The degree of influence of reflection waves may differ depending on the frequency. According to a configuration in which the correction value is generated based on the reception strength at a plurality of frequencies, the correction value can be set to a more proper value.

In addition, when the user uses the vehicle Hv for the first time, for example, if the characteristic data of the user device 9 is not registered in the smart ECU 2, the smart ECU 2 automatically executes the request confirmation process. Furthermore, if a response instructing the start of the characteristic learning process is received as a result of the request confirmation process, the operation procedure is instructed to the user by displaying a characteristic registration guide image or the like. According to this configuration, the user can easily register the communication characteristic without any confusion.

### Modifications

The processor 21 may be configured to execute the request confirmation process when a certain period of time (for example, six months or one year) has elapsed since the characteristic data was registered. The characteristic data may have an expiration date. The processor 21 may be configured to automatically delete expired characteristic data. The processor 21 may be configured to execute a request confirmation process when the inside/outside determination fails a predetermined number of times (for example, once or twice). The feature that the inside/outside determination has failed may be input by the user via the input device 5, 92. In addition, the processor 21 may determine that the inside/outside determination has failed if the device position is determined to be outside the vehicle (for example, in the proximity area) and the activation operation is performed a predetermined number of times within a certain period of time. The activation operation is an operation for turning on the vehicle power source. The activation operation may be an operation of pressing a start switch (in other words, a power switch) while depressing the brake pedal.

The measurement value β1 used to calculate the inner correction value may be a value obtained by subtracting the proximity measurement value from the inner measurement value. The inner measurement value here may be the average value of the reception strength observed at the inner anchor when the user device 9 is placed in the inner set position. The proximity measurement value may be the average value of the reception strength observed at the inner anchor when the user device 9 is placed in the first outer set position. The average value may be a strength average value at multiple frequencies. When the measurement value β1 is a value obtained by subtracting the proximity measurement value from the inner measurement value, the reference value α1 may also be a value calculated under the same conditions. That is, the reference value α1 may also be a value obtained by subtracting the proximity measurement value from the inner measurement value observed using the reference device.

The above description describes the patterns for correcting the reception strength using the characteristic data, but the object of correction may not be the reception strength, but thresholds such as the activation strength, the inside compartment determination strength, the strength difference threshold, and the proximity determination strength. The processor 21 may determine the device position by comparing the actual reception strength with a threshold corrected by the characteristic data.

The processor 21 may have a function of receiving the orientation-related data, which is data indicating the device orientation, from the user device 9 and determining whether the user device 9 is in a specific orientation. The orientation-related data may be data including some or all of the detection results of the magnetic sensor, the acceleration sensor, and the gyro sensor. If the processor 21 detects that the user device 9 is not in the specific orientation based on the received orientation-related data, the processor 21 may perform processing to display an image on the display requesting that the device orientation should be adjusted.

The processor 21 may execute the strength measurement process for determining the inner correction value when there is no occupant inside the compartment of the vehicle and all the doors are closed. Closing the doors creates a multipath environment inside the compartment of the vehicle, which is expected to mitigate the effects of device orientation. Additionally, the device signals can be attenuated by the human body. By setting the compartment of the vehicle with no occupant, the influence of the human body on the inner correction value can be reduced. In view of the above, the processor 21 may request the user to exit the compartment of the vehicle and close all doors once the user device 9 is placed in the inner set position. The user may be notified of the request using a screen display or an audio message.

The processor 21 may determine whether all the doors are closed from an output signal of an in-vehicle sensor (e.g., a courtesy switch). During the inner strength measurement process, if the processor 21 detects from the output signal of the in-vehicle sensor that some of the doors are open, the processor 21 may display on the in-vehicle display 4 an image requesting that all doors should be closed.

The processor 21 may detect whether or not there is an occupant in the compartment of the vehicle from the output signals of in-vehicle sensors such as a seating sensor and an in-vehicle camera. In the inner strength measurement process, if the processor 21 detects that there is an occupant inside the compartment of the vehicle from the output signal of the in-vehicle sensor, the processor 21 may perform a process of outputting an image/audio for requesting the occupant to exit the vehicle.

In the outer strength measurement process, the processor 21 may request the user to hold the user device 9 in his/her hand so that the user device 9 is positioned between the vehicle Hv and the user. This positional relationship reduces the risk of the device signal being attenuated by the human body. In addition, the user's body may act as a blocker for waves reflected from walls and the like. In the outer strength measurement process, the processor 21 may instruct the user to stand facing the vehicle Hv and hold the user device 9 in a predetermined orientation. In the outer strength measurement process, by requesting the user to stand facing the vehicle Hv, it is expected that the strength of the direct wave can be increased while suppressing the reflection wave. Instructions/requests to the user may be given by displaying images or outputting audio.

The strength measurement process at the inner set position may include observing the reception strength when the user device 9 is placed at the inner set position in different orientations. For example, the strength measurement process at the inner set position may be performed in a pattern in which the user device 9 is placed in a first inner orientation and a pattern in which the user device 9 is placed in a second inner orientation. The first inner orientation may be an orientation in which the screen of the user device 9 faces upward. The second inner orientation may be an orientation in which the screen of the user device 9 faces downward.

Furthermore, the inner set position is not limited to one location. The smart ECU 2 may be set with a first inner set position and a second inner set position. When the first inner set position is on the center console, the second inner set position may be in the center of the rear seat, or the like. The second inner set position may be in the trunk.

As described above, the processor 21 may calculate the correction value by averaging the reception strength measured under a plurality of measurement conditions in which the physical states (i.e., positions/postures) of the user device 9 are different. According to this configuration, the accuracy of the correction value can be improved.

The above describes a feature in which the outer correction value is determined based on the reception strength observed at the outer anchor when the user device 9 is placed in a predetermined position outside the vehicle (e.g., the second outer set position), but the feature is not limited to this feature. The outer correction value may be determined based on the reception strength observed when the user device 9 is disposed anywhere outside the vehicle. Here, the reception strength may be attenuated depending on the distance between the communication devices. If the device position is not specified in the outer strength measurement process due to such circumstances, the processor 21 may correct the reception strength based on the distance measurement value. The processor 21 may determine the outer correction value based on the reception strength at the outer anchor corrected based on the distance measurement value.

The above describes a feature in which the inner correction value is determined based on the reception strength observed at the inner anchor when the user device 9 is placed in a predetermined position in the compartment of the vehicle (e.g., the inner set position), but the feature is not limited to this feature. The inner correction value may be determined based on the reception strength observed when the user device 9 is disposed anywhere in the compartment of the vehicle.

The smart ECU 2 (i.e., the processor 21) may be configured to transmit a characteristic report to a predetermined server via cellular communication based on the execution of the characteristic learning process. A characteristic report is a data set including the characteristic data of the user device 9. The characteristics report may include, in addition to the characteristic data, vehicle model information of the vehicle Hv and model information of the user device 9. The server may be a server managed by a vehicle manufacturer or a business entity that provides a car sharing service. The server may be referred to as a center. It should be noted that the user device 9 may transmit the characteristic report instead of the processor 21. The user device 9 may be configured to obtain the characteristic data from the smart ECU 2 at the SRWC.

The server may statistically generate the correction values according to the combination of the vehicle type and model based on characteristic reports received from multiple smart ECUs 2 or user devices 9 and distribute them to the user devices 9. For example, the server may generate various correction values for the same combination of vehicle model and type by averaging characteristic data shown in multiple characteristic reports for that combination. With this configuration, the accuracy of the correction value can be improved. Furthermore, according to the above-described configuration in which the server generates and distributes the correction values, it may be possible to register the characteristic data in the user device 9 and/or the smart ECU 2 that has not yet performed the characteristic learning process. Furthermore, if the server is a server for a car sharing service, the server may distribute in advance a correction value suited to the combination of the user device 9 and the service car to the vehicle that the user has reserved for use. According to this system, it is possible to improve the accuracy of position determination even in a vehicle that a user is using for the first time. As a result, convenience for the user can be improved.

### CS Distance Measurement

Here, the CS distance measurement will be additionally described. The CS distance measurement process includes a step of collecting the reception phase for each channel, a step of calculating a phase change coefficient from the reception phase for each channel, and a step of calculating data indicating the distance (i.e., the distance measurement value) from the phase change coefficient.

The reception phase for each channel may be collected by the anchor 3 and the user device 9 transmitting and receiving CW signals while switching channels in sequence. The anchor 3 and the user device 9 may collect the reception phases for all channels available in the SRWC, or may collect the reception phases for a predetermined number of channels (for example, 10 channels).

The phase change coefficient is a parameter indicating the degree of change in the reception phase according to the change in frequency. The phase change coefficient can also be referred to as a phase change degree, a phase shift amount, or a correlation coefficient between the phase and the frequency. The anchor 3 may calculate a regression line that indicates the relationship between the frequency and the reception phase based on the reception phase for each channel, and use the slope of the regression line as the phase change coefficient. This is because the slope of the regression line indicates the displacement amount of the reception phase with respect to the frequency shift amount. The regression line and its slope can be calculated using a variety of methods, such as the least squares method. The anchor 3 may calculate the phase difference, the differential frequency, and the degree of phase change for each combination of frequencies for which the reception phase can be observed. The anchor 3 may use the average value or median value of the phase change degree for each combination of frequencies as the phase difference change coefficient. The phase difference is the difference in the reception phase observed at the two frequencies. The differential frequency is the difference between the two frequencies, and the degree of the phase change is the value obtained by dividing the phase difference by the differential phase difference. The phase change coefficient corresponds to a parameter obtained by averaging the degree of phase change in a combination of multiple frequencies. The phase change degree and the phase change coefficient correspond to the amount of phase angle displacement caused by a change in the usage frequency.

Calculating the distance measurement from the phase variation coefficient may be performed using the following relationship. There is a relationship of an expression of “D∝C·Δφ/(2π·Δf)” among the device distance defined as D, the differential frequency defined as Δf, and the phase difference defined as Δφ. There is a relationship of an expression of “α=Δφ/Δf” among the phase change coefficient defined as α, the differential frequency defined as Δf, and the phase difference defined as Δφ. From the above relationship, the anchor 3 can calculate the device distance using an expression of “D=k·C·α/2π”. The parameter “C” in the expression indicates the propagation speed of radio waves (i.e., 3×10\hat{ }8 m/sec). The parameter “k” is a design value and is set to 1.0 or 0.5. If D is the one-way distance, k may be set to 0.5. Alternatively, k may be set to 1 if D is the round trip distance.

In addition, multiple anchors 3 may detect the reception phase for each channel by individually transmitting and receiving CW signals to and from user devices 9, or may collect the reception phase for each channel by using sniffing (or sniffering) technology. The sniffing or the sniffering is a technique in which multiple anchors 3 observe the communication between the user device 9 and the gateway module using the channel information provided by the gateway module. The gateway module is one of the SRWC modules mounted in the vehicle Hv that is responsible for two-way communication with the user device 9. The gateway module may be a wireless communication module 24. The channel information is information indicating a channel used for data communication between the gateway module and the user device 9. The channel information may be a specific channel number or a parameter (so-called hop increment) indicating a transition rule of a usage channel. The channel information may preferably include a current use channel number and a hop increment.

In short-range communication such as Bluetooth LE, frequency hopping is performed after communication is established, so that normally only the gateway module that is connected to the communication can capture the data signal from the user device 9. In contrast, with sniffing techniques, channel information is spread to each anchor 3, so that the anchor 3 can also capture the data signal from the user device 9. This is because, by referring to the channel information, the anchor 3 can recognize which of the many channels available in close proximity should be received to receive a signal from the user device 9. As a result, the anchor 3 can detect the reception strength, the reception phase, the reception time, and the like of the signal from the user device 9 without establishing a communication connection. Therefore, a configuration that applies sniffing technique has the advantage that multiple SRWC modules can calculate the distance measurements and detect the reception strength in parallel. Although the anchor 3 calculates the distance measurement value in this supplementary explanation, the processor 21 may collect reception phase information for each channel from the anchor 3 and calculate the distance measurement value.

### Communication Method

The method of data communication between the user device 9 and the smart ECU 2 is not limited to Bluetooth LE, but may also be Bluetooth Classic, Wi-Fi (registered trademark), EnOcean (registered trademark), Zigbee (registered trademark), and the like. The wireless protocol used for the data communication (i.e., the communication connection) may be referred to as a first wireless protocol, and the wireless protocol used for the distance measurement communication may be referred to as a second wireless protocol.

The distance measurement communication may be performed using a communication method other than the Bluetooth LE. For example, the anchor 3 may be configured to be able to perform the distance measurement communication by UWB communication. UWB communication is wireless communication using the UWB-IR (Ultra-Wide Band-Impulse Radio) method. The anchor 3 and the user device 9 may be configured to be able to transmit and receive impulse-shaped radio waves (hereinafter, referred to as impulse signals) used in the UWB communication. An impulse signal used in the UWB communication may be a signal having an extremely short pulse width (for example, 2 nanoseconds) and a bandwidth of 500 MHz (strictly speaking, 499.2 MHz) or more (i.e., an ultra-wide bandwidth). Hereinafter, a UWB signal may be understood as a signal transmitting and receiving via the UWB communication.

### First Note

The present embodiments also include the following technical features. In addition, methods, programs, and computer-readable storage media on which the programs are stored that correspond to the following technical features are also included within the scope of the present embodiments.

### Technical Feature 1

A position determination system includes: a communication device (3) that is configured to be able to execute wireless communication with a mobile device used by a user of a vehicle using a predetermined communication method; and a control unit (2) that determines a position of the mobile device relative to the vehicle based on a reception strength of a signal from the mobile device received by the communication device. The control unit includes: a threshold storage unit (M2) that registers a threshold value for the reception strength to determine the position of the mobile device, the threshold value being designed based on a communication characteristic of a predetermined reference device; and a characteristic data storage unit (M3) that stores data indicating the communication characteristic of the mobile device. The control unit is configured to execute: acquiring the reception strength of the signal from the communication device; generating characteristic data indicating a difference in the communication characteristic between the mobile device and the reference device based on the reception strength of the signal detected when the mobile device is disposed in a predetermined position; storing generated characteristic data in the characteristic data storage unit; and determining the position of the mobile device based on the characteristic data stored in the characteristic data storage unit, the reception strength of the signal detected by the communication device, and the threshold value.

The above-mentioned predetermined position may not refer to a pinpoint location, but may be understood as a predetermined area having a diameter of about 0.5 meters. The predetermined position may be inside or outside a compartment of the vehicle. The threshold value may be the activation strength or may be a threshold value used for determining whether it is disposed inside the compartment of the vehicle or outside the vehicle, such as an inside compartment determination strength.

### Technical Feature 2

In the position determination system according to technical feature 1, the communication device is an inner communication device (3p, 3q) that is disposed inside a compartment of the vehicle. The predetermined position is a position inside the compartment of the vehicle. The communication method is a predetermined communication method that can use a plurality of frequencies. The control unit is configured to execute: acquiring the reception strength at the plurality of frequencies from the inner communication device; calculating an average value of the reception strength for each frequency; and generating the characteristic data based on the average value.

### Technical Feature 3

In the position determination system according to technical feature 2, the control unit is configured to execute: acquiring the reception strength for each frequency in a situation where the mobile device is placed at the predetermined position with a first orientation; acquiring the reception strength for each frequency in a situation where the mobile device is placed at the predetermined position with a second orientation which is different from the first orientation; and generating the characteristic data based on the average value of the reception strength for each frequency acquired when the mobile device is placed at the predetermined position with the first orientation and the reception strength for each frequency acquired when the mobile device is placed at the predetermined position with the second orientation.

### Technical Feature 4

In the position determination system according to technical feature 2 or 3, the communication device include a plurality of inner communication devices (3p, 3q) that are disposed inside the compartment of the vehicle. The control unit is configured to execute: acquiring the reception strength for each frequency detected by each of the plurality of inner communication devices while the mobile device is placed at the predetermined position; and generating the characteristic data based on the average value of the reception strength for each frequency detected by each of the plurality of inner communication devices.

### Technical Feature 5

In the position determination system according to any one of technical features 1 to 4, the communication device is an inner communication device (3p, 3q) that is disposed inside a compartment of the vehicle. The predetermined position is a position inside the compartment of the vehicle. The control unit is configured to execute: determining whether there is an occupant in the compartment of the vehicle based on a signal from an in-vehicle sensor; and causing the communication device to perform the wireless communication to generate the characteristic data when it is determined that there is no occupant in the compartment of the vehicle.

### Technical Feature 6

In the position determination system according to any one of technical features 1 to 4, the communication device is an inner communication device (3p, 3q) that is disposed inside a compartment of the vehicle. The predetermined position is a position inside the compartment of the vehicle. The control unit is configured to execute: determining whether all doors of the vehicle are closed based on a signal from an in-vehicle sensor; determining whether the mobile device is placed at the predetermined position based on a signal from the in-vehicle sensor, an input device installed in the vehicle, the mobile device, or the communication device; and causing the communication device to perform the wireless communication to generate the characteristic data when it is determined that the all doors of the vehicle are closed and the mobile device is placed at the predetermined position.

### Technical Feature 7

In the position determination system according to any one of technical features 1 to 6, the characteristic data is data indicating a difference between an estimation value of the reception strength of the signal transmitted from the reference device and the reception strength of the signal transmitted from the mobile device.

### Technical Feature 8

In the position determination system according to any one of technical features 1 to 7, the communication device includes an outer communication device (3a) that is disposed on an outer surface of the vehicle. The predetermined position is a position disposed outside the vehicle. The control unit is configured to execute: generating the characteristic data based on the reception strength of a signal corresponding to a direct wave, among the reception strength detected when the mobile device is placed at the predetermined position.

### Technical Feature 9

In the position determination system according to technical feature 8, the control unit is configured to execute: acquiring the reception strength of the direct wave in a situation where the mobile device is placed at the predetermined position with a plurality of different orientations; and generating the characteristic data based on a maximum value of the reception strength for each of the plurality of different orientations.

### Technical Feature 10

In the position determination system according to technical feature 8 or 9, the communication device includes a plurality of outer communication devices that are disposed on an outer surface of the vehicle.

The control unit is configured to execute: acquiring the reception strength of the direct wave detected by each of the plurality of outer communication devices while the mobile device is placed at the predetermined position; and generating the characteristic data based on a maximum value of the reception strength of the direct wave detected by each of the plurality of outer communication devices.

### Technical Feature 11

In the position determination system according to any one of technical features 8 to 10, the control unit is configured to execute: causing the outer communication device to perform distance measurement communication, which is the wireless communication for measuring a distance to the mobile device; acquiring, from the outer communication device or the mobile device, a distance measurement value indicating the distance from the outer communication device to the mobile device as a result of the distance measurement communication; correcting the reception strength based on the distance measurement value and the characteristic data; and generating the characteristic data based on corrected reception strength.

### Second Note

The various flowcharts shown in the present disclosure are all examples, and the number of processes constituting the flowcharts and the execution order of the processes can be changed as appropriate. The controls shown in the flowcharts may be combined or executed in parallel as long as there is no contradiction. The terms of acquiring, determining, detecting, generating, and calculating may be used interchangeably. The acquiring certain data by a certain device also includes generating the data from a signal input by the device from another device/sensor.

The device, the system and the method therefor which have been described in the present disclosure may be also realized by a dedicated computer which constitutes a processor programmed to execute one or more functions concretized by computer programs. The device and the method described in the present disclosure may be also implemented by a dedicated hardware logic circuit. Further, the device and the method described in the present disclosure may be also implemented by one or more dedicated computers which are constituted by combinations of a processor for executing computer programs and one or more hardware logic circuits. The processor may be any type of an arithmetic core such as a CPU, an MPU, a GPU, a DFP (i.e., Data Flow Processor) or the like. The processor in the present embodiments may be understood as a device that performs predetermined processing based on an input signal and generates and outputs a signal/data different from the input signal. Some or all of the functions of the smart ECU may be realized using a system-on-chip (SoC), an integrated circuit (IC), or a field-programmable gate array (FPGA).

A computer program includes instructions that are executed by a computer. The computer program may be stored on a computer-readable non-transitory tangible storage medium. The computer program storage medium may be a variety of media such as a hard-disk drive (HDD), a solid-state drive (SSD), or a flash memory.

It is noted that a flowchart or the processing of the flowchart in the present application includes sections (also referred to as steps), each of which is represented, for instance, as S11. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A position determination system comprising:
a communication device that is configured to be able to execute wireless communication with a mobile device used by a user of a vehicle using a predetermined communication method; and
a controller that determines a position of the mobile device relative to the vehicle based on a reception strength of a signal from the mobile device received by the communication device, wherein:
the controller includes:
at least one of (i) a circuit and (ii) a processor with a memory storing computer program code executable by the processor;
a threshold storage that registers a threshold value for the reception strength to determine the position of the mobile device, the threshold value being designed based on a communication characteristic of a predetermined reference device; and
a characteristic data storage that stores data indicating the communication characteristic of the mobile device; and
the at least one of the circuit and the processor is configured to cause the controller to execute:
acquiring the reception strength of the signal from the communication device;
generating characteristic data indicating a difference in the communication characteristic between the mobile device and the reference device based on the reception strength of the signal detected when the mobile device is disposed in a predetermined position;
storing generated characteristic data in the characteristic data storage; and
determining the position of the mobile device based on the characteristic data stored in the characteristic data storage, the reception strength of the signal detected by the communication device, and the threshold value.

2. The position determination system according to claim 1, wherein:
the communication device is an inner communication device that is disposed inside a compartment of the vehicle;
the predetermined position is a position inside the compartment of the vehicle;
the communication method is a predetermined communication method that can use a plurality of frequencies; and
the at least one of the circuit and the processor is configured to cause the controller to execute:
acquiring the reception strength at the plurality of frequencies from the inner communication device;
calculating an average value of the reception strength for each frequency; and
generating the characteristic data based on the average value.

3. The position determination system according to claim 2, wherein:
the at least one of the circuit and the processor is configured to cause the controller to execute:
acquiring the reception strength for each frequency in a situation where the mobile device is placed at the predetermined position with a first orientation;
acquiring the reception strength for each frequency in a situation where the mobile device is placed at the predetermined position with a second orientation which is different from the first orientation; and
generating the characteristic data based on the average value of the reception strength for each frequency acquired when the mobile device is placed at the predetermined position with the first orientation and the reception strength for each frequency acquired when the mobile device is placed at the predetermined position with the second orientation.

4. The position determination system according to claim 2, wherein:
the communication device includes a plurality of inner communication devices that are disposed inside the compartment of the vehicle; and
the at least one of the circuit and the processor is configured to cause the controller to execute:
acquiring the reception strength for each frequency detected by each of the plurality of inner communication devices while the mobile device is placed at the predetermined position; and
generating the characteristic data based on the average value of the reception strength for each frequency detected by each of the plurality of inner communication devices.

5. The position determination system according to claim 1, wherein:
the communication device is an inner communication device that is disposed inside a compartment of the vehicle;
the predetermined position is a position inside the compartment of the vehicle;
the at least one of the circuit and the processor is configured to cause the controller to execute:
determining whether there is an occupant in the compartment of the vehicle based on a signal from an in-vehicle sensor; and
causing the communication device to perform the wireless communication to generate the characteristic data when it is determined that there is no occupant in the compartment of the vehicle.

6. The position determination system according to claim 1, wherein:
the communication device is an inner communication device that is disposed inside a compartment of the vehicle;
the predetermined position is a position inside the compartment of the vehicle;
the at least one of the circuit and the processor is configured to cause the controller to execute:
determining whether all doors of the vehicle are closed based on a signal from an in-vehicle sensor;
determining whether the mobile device is placed at the predetermined position based on a signal from the in-vehicle sensor, an input device installed in the vehicle, the mobile device, or the communication device; and
causing the communication device to perform the wireless communication to generate the characteristic data when it is determined that the all doors of the vehicle are closed and the mobile device is placed at the predetermined position.

7. The position determination system according to claim 1, wherein:
the characteristic data is data indicating a difference between an estimation value of the reception strength of the signal transmitted from the reference device and the reception strength of the signal transmitted from the mobile device.

8. The position determination system according to claim 1, wherein:
the communication device includes an outer communication device that is disposed on an outer surface of the vehicle;
the predetermined position is a position disposed outside the vehicle; and
the at least one of the circuit and the processor is configured to cause the controller to execute:
generating the characteristic data based on the reception strength of the signal corresponding to a direct wave, among the reception strength detected when the mobile device is placed at the predetermined position.

9. The position determination system according to claim 8, wherein:
the at least one of the circuit and the processor is configured to cause the controller to execute:
acquiring the reception strength of the direct wave in a situation where the mobile device is placed at the predetermined position with a plurality of different orientations; and
generating the characteristic data based on a maximum value of the reception strength for each of the plurality of different orientations.

10. The position determination system according to claim 8, wherein:
the communication device includes a plurality of outer communication devices that are disposed on an outer surface of the vehicle;
the at least one of the circuit and the processor is configured to cause the controller to execute:
acquiring the reception strength of the direct wave detected by each of the plurality of outer communication devices while the mobile device is placed at the predetermined position; and
generating the characteristic data based on a maximum value of the reception strength of the direct wave detected by each of the plurality of outer communication devices.

11. The position determination system according to claim 8, wherein:
the at least one of the circuit and the processor is configured to cause the controller to execute:
causing the outer communication device to perform distance measurement communication, which is the wireless communication for measuring a distance to the mobile device;
acquiring, from the outer communication device or the mobile device, a distance measurement value indicating the distance from the outer communication device to the mobile device as a result of the distance measurement communication;
correcting the reception strength based on the distance measurement value and the characteristic data; and
generating the characteristic data based on corrected reception strength.

12. The position determination system according to claim 1, wherein:
the mobile device functions as a wireless key of the vehicle to open and close a door of the vehicle;
the communication device functions as a wireless communication module to execute short-range wireless communication; and
the controller executes to open and close the door of the vehicle when the mobile device is disposed in a proximity area of the vehicle, the mobile device is authenticated, and the user of the vehicle takes a predetermined action.

13. The position determination system according to claim 12, wherein:
the communication device includes an antenna for the short-range wireless communication, a transmission and reception circuit, and a short-range wireless communication controller;
the short-range wireless communication controller executes a distance measurement communication, which is the short-range wireless communication for measuring a distance to the mobile device;
the short-range wireless communication controller generates data of a result of distance measurement; and
the short-range wireless communication controller transmits the data of the result of distance measurement to the controller.

14. A position determination method comprising:
acquiring a reception strength of a signal from a mobile device through a communication device which is configured to be able to execute wireless communication with the mobile device in a predetermined communication method;
accessing a threshold storage unit which registers a threshold value for the reception strength to determine a position of the mobile device, the threshold value being designed based on communication characteristic of a predetermined reference device;
reading out the threshold value from the threshold storage unit;
generating characteristic data indicating the communication characteristic of the mobile device based on the reception strength of the signal detected when the mobile device is disposed in a predetermined position;
storing generated characteristic data in a characteristic data storage unit; and
determining the position of the mobile device based on the characteristic data stored in the characteristic data storage unit, the reception strength of the signal detected by the communication device, and the threshold value.

15. The position determination method according to claim 14, wherein:
the mobile device functions as a wireless key of the vehicle to open and close a door of the vehicle; and
the communication device functions as a wireless communication module to execute short-range wireless communication,
the position determination method further comprising:
executing to open and close the door of the vehicle when the mobile device is disposed in a proximity area of the vehicle, the mobile device is authenticated, and a user of the vehicle takes a predetermined action.

16. The position determination method according to claim 15, wherein:
the communication device includes an antenna for the short-range wireless communication, a transmission and reception circuit, and a short-range wireless communication controller;
the short-range wireless communication controller executes a distance measurement communication, which is the short-range wireless communication for measuring a distance to the mobile device;
the short-range wireless communication controller generates data of a result of distance measurement; and
the short-range wireless communication controller transmits the data of the result of distance measurement.

17. A non-transitory tangible computer readable storage medium comprising instructions being executed by a computer, the instructions including a computer-implemented method for determining a position of a vehicle, the instructions including:
acquiring a reception strength of a signal from a mobile device through a communication device which is configured to be able to execute wireless communication with the mobile device in a predetermined communication method;
accessing a threshold storage unit which registers a threshold value for the reception strength to determine a position of the mobile device, the threshold value being designed based on communication characteristic of a predetermined reference device;
reading out the threshold value from the threshold storage unit;
generating characteristic data indicating the communication characteristic of the mobile device based on the reception strength of the signal detected when the mobile device is disposed in a predetermined position;
storing generated characteristic data in a characteristic data storage unit; and
determining the position of the mobile device based on the characteristic data stored in the characteristic data storage unit, the reception strength of the signal detected by the communication device, and the threshold value.

18. The non-transitory tangible computer readable storage medium according to claim 17, wherein:
the mobile device functions as a wireless key of the vehicle to open and close a door of the vehicle;
the communication device functions as a wireless communication module to execute short-range wireless communication; and
the instructions further includes: executing to open and close the door of the vehicle when the mobile device is disposed in a proximity area of the vehicle, the mobile device is authenticated, and a user of the vehicle takes a predetermined action.

19. The non-transitory tangible computer readable storage medium according to claim 18, wherein:
the communication device includes an antenna for the short-range wireless communication, a transmission and reception circuit, and a short-range wireless communication controller;
the short-range wireless communication controller executes a distance measurement communication, which is the short-range wireless communication for measuring a distance to the mobile device;
the short-range wireless communication controller generates data of a result of distance measurement; and
the short-range wireless communication controller transmits the data of the result of distance measurement.
